(19) United States
(12) Patent Application Publication
(10) Pub. No.: US 2009/0082409 A1
(43) Pub. Date: Mar. 26, 2009

(54) Steam stripping polymer dispersions to improve biocide stability

(76) Inventors: James Kent Carpenter, Lambertville, NJ (US); Colin Gouveia, Fort Washington, PA (US); Zoya Rudik, Horsham, PA (US); Jeremia Jesaja Venter, Warrington, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 12/283,176

(22) Filed: Sep. 10, 2008

Related U.S. Application Data
(60) Provisional application No. 60/994,974, filed on Sep. 24, 2007.

(51) Int. Cl. A01N 43/80; A01N 25/04

(52) U.S. Cl. 514/372; 514/772.6

(57) ABSTRACT

A process for stabilizing biocide compounds in a polymer dispersion requiring stripping of the dispersion using steam or an inert gas.

This application claims the benefit of priority under 35 U.S.C. §119(e) of U.S. Provisional Patent Application No. 60/994,974 filed on Sep. 24, 2007.

The present invention relates to a process for stripping polymer dispersions or as used herein, “dispersions”, as a treatment to stabilize biocides.

As used herein by biocide is meant 3-Isothiazolone compounds of the form:

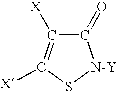

Where Y is an alkyl or substituted alkyl of 1 to 18 carbon atoms; an unsubstituted or halogen substituted alkenyl or alkynyl of about 2 to 8 carbon atoms; a cycloalkyl or substituted cycloalkyl or substituted cycloalkyl of about 3 to 12 carbon atoms; an aralkyl or halogen-, lower alkyl-, or lower alkoxy-substituted aralkyl of up to about 10 carbon atoms; or an aryl or halogen-, lower alkyl-, or lower alkoxy-substituted aryl of up to about 10 carbon atoms or hydrogen; X and X′ are hydrogen, halogen, or a (C1-C4) alkyl; and X and X′ combined are a fused aromatic.

These are a very important class of microbiocides. Several species have been commercialized and are widely used to inhibit the growth of bacteria, fungi, and algae. Some examples are methyl isothiazolone and 5-chloro 2-methyl 3-isothiazolone, 2-methyl 3-isothiazolone, 2-n-octyl 3-isothiazolone, and 1,2-benz 3-isothiazolone.

The use of isothiazolone compounds as biocides, particularly 3-isothiazolones to control microbial growth in emulsions is well known to those experienced in the art. However one problem that exists with using isothiazolones in the polymer dispersion is that these compounds can be broken down by oxidizers and reductants found in the polymer dispersion, thus reducing the efficacy of the isothiazolones for preventing microbial growth.

As a solution to this problem, the art has attempted to stabilize these biocides. Traditionally, isothiazolone compounds have been stabilized in the dispersion environment by using inorganic metal compounds. Such inorganic metal compounds include but are not limited to metal nitrates and metal nitrate salts. Additionally, the use of copper as a stabilizing agent is well known. Although these metals help to stabilize the biocide components, their use is often undesirable in many applications. Metal compounds with higher valences can destabilize the dispersions. Destabilizing the dispersion creates aggregates known as gels which can detract from the performance of the dispersion.

The present invention alleviates the need to use these metal compounds by stripping the dispersion, thus improving the stability of the isothiazolones.

In the present invention there is provided a process for stabilizing biocides in aqueous polymer dispersions comprising:

providing an aqueous polymer dispersion and steam;

contacting the aqueous polymer dispersion and steam in a stripper;

separating the steam from the aqueous polymer dispersion;

wherein at least one biocide is added after the aqueous polymer dispersion and steam is contacted in the stripper.

Aqueous polymer dispersions of the present invention may be prepared by emulsion, miniemulsion, or suspension, polymerization. Polymers formed by solution polymerization are specifically not contemplated by the present invention.

As used herein, steam is defined as an inert gas, or a combination of non-condensable inert gases saturated with water vapor.

The polymer dispersion and steam mixture may be contacted in a batch or continuous stripping apparatus. If continuous, the feed may be co-current or counter-current. As used herein “co-current” means both dispersion and steam enter and exit the stripper together. As used herein, counter-current means the dispersion enters the stripper where the steam exits and the steam enters the stripper where the dispersion exits.

The stripper apparatus may be operated in a batch, 1-stage continuous, or multi-stage continuous process. To that end, a single stripper, multiple strippers, single condenser, or multiple condensers may be used as the stripping apparatus. Any stripper apparatus currently known to those of ordinary skill in the art would be applicable to the present invention. Non-limiting examples of stripper apparatuses useful in the present invention include batch vacuum tank, jacketed, single pass shell and tube heat exchangers, multiple pass shell and tube heat exchangers, and spiral heat exchangers. There may be a single tube or multiple tubes in the shell of the stripper.

In one embodiment of the present invention, at least one biocide is added to the polymer dispersion and steam mixture prior to being fed into the stripper. In a second embodiment of the present invention, the at least one biocide is added to the polymer dispersion and steam mixture after the mixture has been stripped. Non-limiting examples of biocides useful for the present invention include methyl isothiazolone and 5-chloro 2-methyl 3-isothiazolone, 2-methyl 3-isothiazolone, 2-n-octyl 3-isothiazolone, and 1,2-benz 3-isothiazolone or mixtures thereof.

The dispersion polymers of the present invention are stripped at temperatures below 80° C. Stripping at higher temperatures, eg. Greater than 80° C. causes undesirable properties such as gel formation and fouling of the equipment with the dispersion polymer.

The amount of biocide remaining in the compound mixture can be measured over time. This is referred to as the biocide stability. One advantage of the present invention is that after 7 days of shelf life at 50° C., up to 80% more of the original isothiazolone by weight is found in the stripped stabilized material over a similarly situated unstripped sample. After 14 days, at 50° C., up to 45% more of the original isothiazolone by weight is found in the stripped stabilized material over a similarly situated unstripped sample.

The following is a non-limiting example that illustrates a few of the advantages of the present invention.

### EXAMPLE

### Test Method

### Heat Stabilization Test

28 grams of dispersion sample are placed in an oven at 50° C. At the end of seven days 1 gram of sample is removed for active ingredient analysis, to be measured according to the method below. At the end of fourteen days a second gram of sample is analyzed. The level of isothiazolone compound is measured in the material by the method described below. The results are compared against a zero time control. The control is a sample that has not been placed in the oven. The control is assayed on receipt.

### Isothiazolone Level Measurement

Dilute the dispersion sample with deionized water at a ratio of 9 parts water to 1 part dispersion. Mix the sample to extract the isothiazolone into the water (aqueous) phase. Centrifuge the sample and extract the clear liquid phase. Inject the clear liquid into HPLC testing machine, eg. Agilent 1100 Series, to measure the level of isothiazolone.

### Example

### Comparison of Isothiazolone Stability for Stripped Versus Unstripped Samples

A polymeric dispersion was prepared in a 5-gallon, batch reactor. The dispersion was a butyl acrylate/styrene water based dispersion. The dispersion polymer was stabilized by surfactant and acrylic acid monomer. Solids of the resulting dispersion was 53-54% by weight. The final pH of the dispersion was between 6.8 and 7.8 and the viscosity was less than 200 cp.

The polymeric sample was separated into four parts. Each part had a combination of methyl isothiazolone (MIT) and chloro methyl isothiazolone (CMIT) added in the following ways:

Part 1. Isothiazolones added after polymerization of the batch.

Part 2. Isothiazolones added two hours after batch polymerization.

Part 3. Isothiazolones added after completion of the batch, then the dispersion sample was steam stripped.

Part 4. The sample is steam stripped; then the isothiazolones were added.

The stripped samples were stripped with three passes through a single stage, continuous stripper. The relative flow rate of steam to dispersion during stripping was 1:5. If the stripped samples showed improved stability, the comparative, unstripped samples would have a lower concentration of biocide after a thermal stability test.

The samples were placed in an oven at 50° C. for two weeks. The level of MIT and CMIT in each sample was measured at zero days, seven days, and fourteen days in the oven to test the stability of the biocide in the dispersion.

Part 2 above was a control sample with the hold period designed to represent the time required for stripping.

The results of the experiment are shown in the tables below:

TABLE 1
Normal Biocide Addition

| Day | MIT level (ppm) | CMIT level (ppm) |
|---|---|---|
| 0 | 271.2 | 29.6 |
| 7 | 42.1 | 0 |
| 14 | 41.9 | 0 |

TABLE 2
Hold for 2 hours, Add Biocide

| Day | MIT level (ppm) | CMIT level (ppm) |
|---|---|---|
| 0 | 272.5 | 30.7 |
| 7 | 40.5 | 0 |
| 14 | 41 | 0 |

TABLE 3
Add Biocide, then strip

| Day | MIT level (ppm) | CMIT level (ppm) |
|---|---|---|
| 0 | 247.4 | 28.2 |
| 7 | 243 | 10.2 |
| 14 | 148.9 | 0 |

TABLE 4
Strip, then add biocide

| Day | MIT level (ppm) | CMIT level (ppm) |
|---|---|---|
| 0 | 270.9 | 33.6 |
| 7 | 242.2 | 6.6 |
| 14 | 74.3 | 0 |

The MIT level in both unstripped samples dropped to 40-43 ppm after 7 days. The CMIT level in these samples dropped to 0 ppm after 7 days. In comparison, the stripped samples after 7 days had MIT levels of 243 and 242 ppm and CMIT levels of 10.2 and 6.6 ppm. After fourteen days no CMIT was detected, but some of the MIT remained in the stripped samples. There was a clear improvement in the stability of both isothiazolones for the stripped samples. The unstripped sample held for two hours before isothiazolone addition showed no difference in biocide level or biocide stability from the sample with isothiazolone added on completion of polymerization.

We claim:

1. A process for stabilizing biocides in aqueous polymer dispersions comprising:
providing an aqueous polymer dispersion and steam;
contacting the aqueous polymer dispersion and steam in a stripper;
separating the steam from the aqueous polymer dispersion;
wherein at least one biocide is added to the aqueous polymer dispersion.

2. The process of claim 1 wherein the at least one biocide is added before contacting the aqueous polymer dispersion and steam in a stripper.

3. The process of claim 1 wherein the at least one biocide is added after contacting the aqueous polymer dispersion and steam in a stripper.

4. The process of claim 1 wherein the at least one biocide is added while contacting the aqueous polymer dispersion and steam in a stripper.

5. The process of claim 2 wherein the at least one biocide is selected from the group consisting of methyl isothiazolone, chloro methyl isothiazolone, or mixtures thereof.

6. The process of claim 3 wherein the at least one biocide is selected from the group consisting of methyl isothiazolone, chloro methyl isothiazolone, or mixtures thereof.

7. The process of claim 4 wherein the at least one biocide is selected from the group consisting of methyl isothiazolone, chloro methyl isothiazolone, or mixtures thereof.

8. The process of claim 1 wherein the stripper temperature is less than 80° C.
